(19) United States
(12) Patent Application Publication
(10) Pub. No.: US 2006/0222573 A1
(43) Pub. Date: Oct. 5, 2006

(54) Test tube holder

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS Co., Ltd., Kumamoto-shi (JP)

(21) Appl. No.: 11/378,649

(22) Filed: Mar. 20, 2006

(30) Foreign Application Priority Data
Mar. 31, 2005 (JP) 2005-100952

(51) Int. Cl. B01L 9/00

(52) U.S. Cl. 422/104

(57) ABSTRACT

A test tube holder includes a holder body which is provided with a cylindrical hollow portion, and a holder unit which is set in the cylindrical hollow portion of the holder body, for holding an arbitrary one of different kinds of test tubes of different diameters and lengths, which is accommodated in the cylindrical hollow portion. The holder unit includes a fixing member set in the cylindrical hollow portion, and a holder spring which includes a plurality of wires annularly arranged and each having a predetermined length. The proximal end portions of the wires are fixed to the fixing member, and the distal end portions of the wires project upwardly from the holder body to form a test-tube holder portion which is elastic in the radius direction of the cylindrical hollow portion.

### CROSS-REFERENCE TO RELATED APPLICATIONS

This application is based upon and claims the benefit of priority from prior Japanese Patent Application No. 2005-100952, filed Mar. 31, 2005, the entire contents of which are incorporated herein by reference.

### BACKGROUND OF THE INVENTION

1. Field of the Invention

The present invention relates to a test tube holder for use in carriage of a test tube containing a specimen such as blood.

2. Description of the Related Art

As a test tube containing a specimen such as blood, the following test tube is known: it is formed of transparent glass or plastic, and a cap formed of rubber or synthetic resin is put on an upper opening portion of the test tube. The test tube is carried to each of processing sections, while being vertically held by a test tube holder which is guided along a carrier passage, in order that the specimen contained in the test tube be aliquoted or dispensed.

Therefore, such a test tube holder is formed to stably and vertically hold an arbitrary one of test tubes of different lengths and diameters, when the held tube is carried. The test tube holder has a base body constituting a holder body. The base body includes an engaging portion such as an annular groove, which is to be engaged with a guide rail of a carrying system, and which is provided at an outer peripheral surface of a proximal end portion of the base body. A cylindrical hollow portion for accommodating the test tube is provided in a center portion of the base body in such a way as to extend from a distal end of the base body to a predetermined depth toward a proximal end of the base body. It should be noted that Jpn. Pat. Appln. KOKAI Publication No. 2003-211006 discloses a test tube holder in which a test tube engagement portion for selectively holding test tubes having different outside diameters is provided in the cylindrical hollow portion of a holder body.

The test tube holder disclosed in Jpn. Pat. Appln. KOKAI Publication No. 2003-211006 has a plurality of leaf springs provided in the cylindrical hollow portion of the holder body. The leaf springs have contact portions with which the outer peripheral surface of a test tube to be held is to be brought into contact. Furthermore, the test tube holder includes a single O-ring which bundles the leaf springs in such a manner as to surround them, in order that the contact portions press the outer peripheral surface of the test tube with a given force.

The structure of the above test tube holder is complicated. The elasticity of the leaf springs is adjusted by the single O-ring. Thus, the parts of the test tube holder cannot be easily assembled, as a result of which the manufacturing cost is increased, and the maintenance is troublesome when the O-ring is damaged or broken.

### BRIEF SUMMARY OF THE INVENTION

A test tube holder according to an aspect of the present invention comprises: a holder body including a cylindrical hollow portion for accommodating an arbitrary one of different kinds of test tubes of different diameters and lengths; and a holder unit which is set in the cylindrical hollow portion of the holder body, for holding the arbitrary one of the different kinds of test tubes, and the holder unit comprises (i) a fixing member set in the cylindrical hollow portion, and (ii) a holder spring which includes a plurality of wires annularly arranged and each having a predetermined length, the wires including proximal end portions which are fixed to the fixing member, and distal end portions which project upwardly from the holder body to form a test-tube holder portion which is elastic in a radius direction of the cylindrical hollow portion.

In addition to the above structure, a test tube holder according to another aspect of the present invention has the following structure in which the fixing member comprises two annular plates which are vertically separated from each other, and the annular plates include a plurality of insertion holes which are annularly arranged and provided for fixing the proximal end portions of the wires, with the proximal end portions inserted in the insertion holes.

Also, in addition to the above structure, a test tube holder according to a further aspect of the present invention has the following structure in which upper end portions of the wires, which correspond to an upper end portion of the test-tube holder, are bent outwardly to form a test-tube guide portion.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawing, which are incorporated in and constitute a part of the specification, illustrate embodiments of the invention, and together with the detailed description of the embodiments given below, serve to explain the principles of the invention.

FIG. 1 is a perspective view of a test tube holder according to a first embodiment of the present invention.

FIG. 2 is a vertical sectional view of the test tube holder according to the first embodiment.

FIG. 3A is a plan view of a holder unit in the first embodiment.

FIG. 3B is a vertical sectional view taken along line a-a in FIG. 3A.

FIG. 4 is a vertical sectional view showing that a test tube is held by the test tube holder according to the first embodiment.

### DETAILED DESCRIPTION OF THE INVENTION

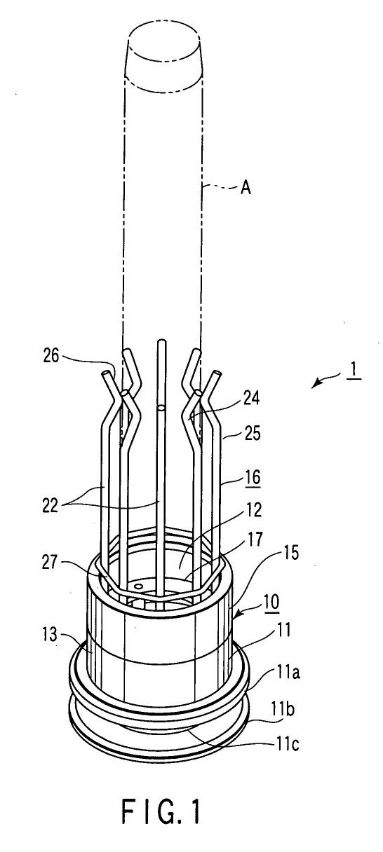

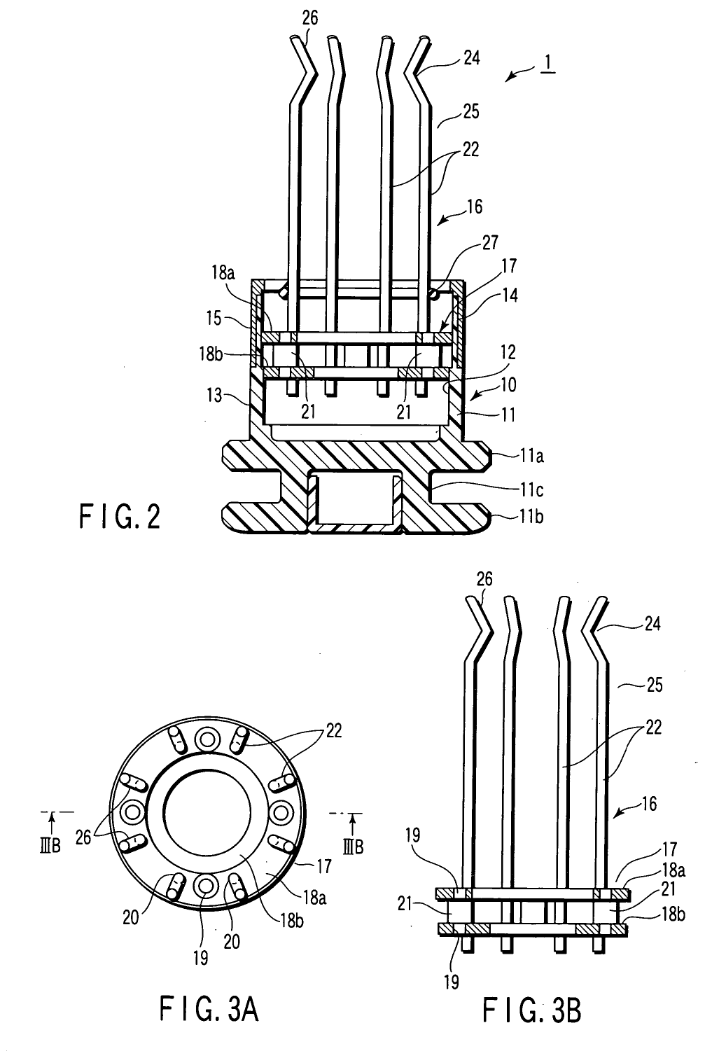

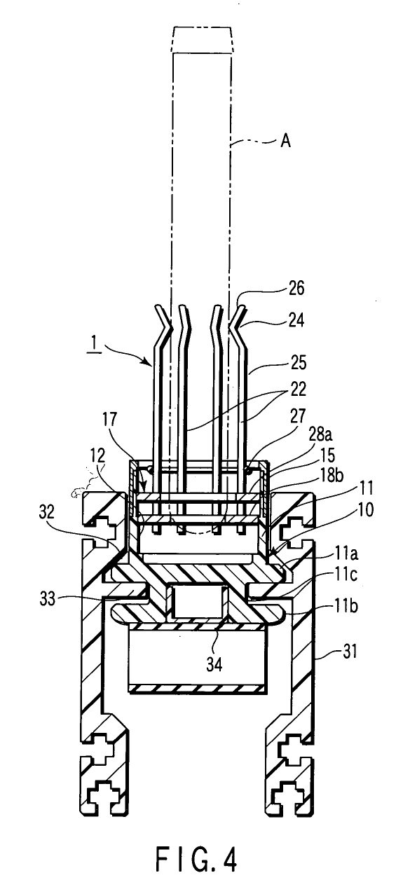

An embodiment of the present invention will be explained with reference to the accompanying drawings. FIGS. 1 to 4 disclose a first embodiment. FIG. 1 is a perspective view of a test tube holder 1 according to the first embodiment. FIG. 2 is a vertical sectional view of the test tube holder 1. FIG. 3A is a plan view of a holder unit. FIG. 3B is a vertical sectional view taken along line a-a in FIG. 3A. FIG. 4 is vertical sectional view showing that a test tube is held by the test tube holder 1.

The test tube holder 1 according to the first embodiment includes a holder body 10 formed of, e.g., synthetic resin material. The holder body 10 includes a cylindrical base body 11. On an outer peripheral surface of a proximal end portion of the cylindrical base body 11, engagement portions, which can be engaged with a carrier rail (which will be described later), are formed. In the first embodiment, as the engagement portions, flange portions 11a and 11b are formed. The flange portions 11a and 11b are vertically arranged in two stages, and an annular groove 11c is provided between the flange portions 11a and 11b.

At a center portion of the cylindrical base body 11, a cylindrical hollow portion 12 for accommodating a test tube is provided to extend from an upper end portion of the cylindrical base body 11 to a depth corresponding to the level of the upper one of the flanges, i.e., the flange 11a. A central portion of the cylindrical base body 11 in the longitudinal direction thereof is provided as a large-diameter portion 13. A distal end portion of the cylindrical base body 11, which is continuous with the large-diameter portion 13, is provided as a small-diameter portion 14. A metal ring 15 is engaged with the small-diameter portion 14, and can be detected by an optical detector.

In the cylindrical hollow portion 12, a holder unit 16 is provided to hold an arbitrary one of test tubes of different diameters and lengths, e.g., a test tube A which is formed of transparent glass or plastic, and contains gathered blood. The holder unit 16 includes a fixing member 17 set in the cylindrical hollow portion 12. The fixing member 17 includes two metallic plates 18a and 18b vertically separated from each other and fixed in the cylindrical hollow portion 12. The plates 18a and 18b each include four attachment holes 19 arranged at regular intervals in a circumferential direction and eight insertion holes 20 arranged at regular intervals in the circumferential direction. The attachment holes 19 and insertion holes 20 of the plate 18a are located vertically opposite to the attachment holes 19 and insertion holes 20 of the plate 18b.

Between the plates 18a and 18b, four spacer rods 21 are provided to extend vertically. Upper and lower end portions of the spacer rods 21 are inserted in the attachment holes 19 formed in the plates 18a and 18b, and are soldered to the plates 18a and 18b. In such a manner, the plates 18a and 18b are vertically spaced from each other and kept parallel to each other. Furthermore, proximal end portions of wires 22 formed of steel wires each having a predetermined length are inserted in the eight insertion holes 20 of each of the plates 18a and 18b, and are soldered to each of the plates 18a and 18b. In such a manner, the wires 22 are annularly arranged at regular intervals, forming a holder spring 25. The wires 22 project upwardly from the holder body 10, and their distal end portions serve as a test tube holder portion 24. The test-tube holder portion 24 is substantially dog-legged as viewed side-on, and can hold test tubes of different diameters and lengths due to the elastic force of the test tube holder portion 24 which acts in the radius direction of the cylindrical hollow portion 12.

Furthermore, an upper end portion of the test tube holder 24 serves as a test-tube guide portion 26. To be more specific, those portions of the wires 22, which correspond to the upper end portion of the test tube 24, are inclined outwardly to serve as the test-tube guide portion 26. On a proximal end side of the holder spring 25, a rubber band 27 is arranged on part of the holder spring 25, which is located close to an open end of the cylindrical hollow portion 12. The rubber band 27 elastically inwardly pushes the holder spring 25, as a result of which the test tube A is reliably held by the test tube holder.

FIG. 4 is a view showing that the test tube A is vertically held by the test tube holder 1, and the test tube holder 1 is supported by a carrier rail 31. In the carrier rail 31, a carrier passage 32 is provided to have a width slightly greater than the outside diameter of the holder body 10 of the test tube holder. At inner surfaces of the carrier passage 32, respective convex portions 33 are formed opposite to each other, and continuously extend in the longitudinal direction of the carrier rail 31. The convex portions 33 are fitted in the annular groove 11c of the holder body 10.

In the carrier passage 32 of the carrier rail 31, a carrier belt 34 is provided and stretched along the carrying direction of the carrier rail 31. A bottom surface of the holder body 10 is provided to contact an upper surface of the carrier belt 34. Therefore, the test tube holder 1 is carried along the carrier passage 32 when the carrier belt 34 is rotated.

As explained above, the test tube holder 1 comprises the holder body 10 provided with the cylindrical hollow portion 12, and the holder unit 16 which is set in the cylindrical hollow portion 12 of the holder body 10, and can hold test tubes of different diameters and lengths, such as the test tube A. The holder unit 16 comprises the two plates 18a and 18b set in the cylindrical hollow portion 12 of the holder body 10, and the holder spring 25 whose proximal end portion is fixed to the plates 18a and 18b, and which is provided with the test-tube holder portion 24 which is elastic in the radius direction of the cylindrical hollow portion 12. The wires forming the holder spring 25 are arranged annularly.

By virtue of the above structure, the test tube holder 1 can reliably hold the midsection of an arbitrary one of test tubes of different diameters and lengths, such as the test tube A, since the holder spring 25 provided with the test-tube holder portion 24 is elastic in the radius direction of the cylindrical hollow portion 12. In such a manner, in the above embodiment, in order to hold each of test tubes of different diameters and lengths, it is not necessary to switch the test tube to be used, between test tube holders respectively adapted for the test tubes. That is, the embodiment provides a single test tube holder 1 which can hold test tubes of different diameters and lengths.

In addition, in the embodiment, the number of parts of the test tube holder is small, and they can be easily assembled, thus reducing the manufacturing cost. Furthermore, the upper end portion of the test-tube holder portion 24 is bent to serve as the test-tube guide portion 26, thereby enabling the test tube A to be more easily inserted from above into the test tube holder, as compared with conventional test tube holders.

The present invention is not limited to the above embodiment, and structural elements in the embodiment can be modified without departing from the subject matter of the present invention, when the invention is put to practical use. Furthermore, various inventions can be made by appropriately combining structural elements in the embodiment. For example, some of the structural elements in the embodiment may be omitted. In addition, structural elements in different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of general inventive concept as defined by appended claims and their equivalents.

What is claimed is:

1. A test tube holder comprises:
a holder body including a cylindrical hollow portion; and
a holder unit which is set in the cylindrical hollow portion of the holder body, for holding an arbitrary one of different kinds of test tubes,
wherein the holder unit comprises (i) a fixing member set in the cylindrical hollow portion, and (ii) a holder spring which includes a plurality of wires annularly arranged and each having a predetermined length, the wires including proximal end portions which are fixed to the fixing member, and distal end portions which project upwardly from the holder body to form a test-tube holder portion which is elastic in a radius direction of the cylindrical hollow portion.

2. The test tube holder according to claim 1, wherein the fixing member comprises two annular plates which are vertically separated from each other, and the annular plates include a plurality of insertion holes which are annularly arranged and provided for fixing the proximal end portions of the wires, with the proximal end portions inserted in the insertion holes.

3. The test tube holder according to claim 1, wherein upper end portions of the wires, which correspond to an upper end portion of the test-tube holder, are bent outwardly to form a test-tube guide portion.
